(19) United States
(12) Patent Application Publication
(10) Pub. No.: US 2025/0316789 A1
(43) Pub. Date: Oct. 9, 2025

(54) BATTERY CARRIER FOR AN ELECTRIC VEHICLE

(71) Applicant: BENTELER AUTOMOBILTECHNIK GMBH, Paderborn (DE)

(72) Inventors: Lars LANDERMANN, Herford (DE); Christian BUSE, Lichtenau (DE); Conrad FRISCHKORN, Paderborn (DE); Martin POHL, Altenbeken (DE)

(21) Appl. No.: 19/172,592

(22) Filed: Apr. 7, 2025

(30) Foreign Application Priority Data
Apr. 8, 2024 (EP) 24169045.2

(51) Int. Cl. H01M 10/6568; H01M 10/613; H01M 10/625; H01M 10/6554; H01M 50/224; H01M 50/242

(52) U.S. Cl. CPC H01M 10/6568; H01M 10/613; H01M 10/625; H01M 10/6554; H01M 50/224; H01M 50/242

(57) ABSTRACT

A battery carrier for an electric vehicle having a battery tray produced as a hot-formed and press-hardened component from a sheet steel plate, having a floor and side walls rising from the floor with a flange encircling the top of the battery tray and projecting outwards. A cooling channel structure is formed integrally in the floor and made from one material, wherein a cover plate is arranged on the floor in the battery tray or a cover plate is arranged underneath the floor of the battery tray in such a way that cooling channels are formed between the cooling channel structure and the cover plate.

### RELATED APPLICATIONS

The present application claims priority of European Application Number 24169045.2 filed Apr. 8, 2024, the disclosure of which is hereby incorporated by reference herein in its entirety.

### FIELD

The present disclosure relates to a battery carrier for an electric vehicle.

### BACKGROUND

The use of electric energy to power motor vehicles has become increasingly popular. In this scenario, an electric motor is used to drive an electric motor vehicle or an electric vehicle. The energy required for this purpose is stored in a battery, so-called batteries or traction batteries, in the electric vehicle. The batteries themselves must be housed in the electric vehicle and must also be tempered, as they heat up during the charging process as well as during a rapid discharging process, for example. For this purpose, battery boxes, so-called battery trays or battery carriers are known, which also have a cooling system.

For example, such a battery carrier is described in DE 10 2019 102 754 A1.

### SUMMARY

The object of the present disclosure relates to the construction of a battery carrier, to improve its cooling capacity and, optionally, to simultaneously improve its crash performance.

The present disclosure relates to a battery carrier for an electric vehicle. The battery carrier is also referred to as a battery tray. The present disclosure therefore also relates to an electric vehicle with a battery carrier or an electric vehicle battery carrier. This battery carrier has a battery tray. The battery tray is made from a sheet metal plate as a hot-formed and press-hardened component. For this purpose, a sheet metal blank made of a hardenable steel alloy is used, for example 22 MnB5. In at least one embodiment of the present disclosure, an anti-corrosion protective coating is present, for example, aluminum-silicon-based and/or zinc-based.

The tray has a floor and side walls rising from the floor with a flange protruding outwards encircling the top of the battery tray. The battery tray is able to be coupled with a cover or a hood using this flange. This creates an interior for storing batteries or traction batteries.

In at least one embodiment of the present disclosure, a cooling channel structure is formed integrally in the floor and made from one material. This means that at least some of the cooling channels are part of the floor itself. A cover plate is then arranged on the floor in the battery tray. In at least one embodiment of the present disclosure, the cooling channel structure is configured as ribs or an embossed structure and is shaped to protrude downwards over the floor for this purpose. A cover plate, which is arranged on the inside of the battery tray on the floor, forms cooling channels between the cover plate and the cooling channel structure in cross-section for the passage of a cooling medium. In at least one embodiment of the present disclosure, the cover plate is flat. In at least one embodiment of the present disclosure, the cover plate has a correspondingly maximized flat surface in order to position the underside or the underbody on the cover plate at the respective battery, so that a correspondingly good heat transfer is able to be achieved and the battery heat is able to be dissipated via the cooling channel structure. In at least one embodiment of the present disclosure, the cover plate and the floor are then coupled to each other in a material-locking manner, or in a fluid-tight manner for the passage of a liquid medium. This coupling is able to be achieved, for example, by means of material bonding, or by means of laser welding.

Alternatively, the cooling channel structure is able to be formed in the form of beads or embossed features pointing inwards into the battery tray. In at least one embodiment of the present disclosure, a cover plate is arranged from below under the floor of the battery carrier. Here, too, cooling channels for conducting a cooling medium are formed between the cooling channel structure and the cover plate in the cross-section.

In the last-mentioned embodiment, an upper surface or an upper surface also referred to as a contact surface is configured to be offset parallel to the ground. The contact surface itself, which is also the upper side of the cooling channel structure, is therefore configured to be flat and parallel to the ground. The cooling channels are therefore configured to be flat. In at least one embodiment of the present disclosure, the width of the cooling channels is able to be between 30 and 70 mm, between 40 and 60 mm, and about 50 mm. The flat contact area and the flat upper side of the cooling channels in turn result in a maximized contact area for coupling with the respective underbodies of batteries. Here, too, heat transfer is able to occur by means of heat conduction from the battery floor into the cooling channels.

In at least one embodiment of the present disclosure, the cooling channel structure has a surface area of the floor in a plan view that that is able to cover 50 to 95%, 60 to 90%, 60 to 80%, and 70 to 80%, of the surface area of the floor. In at least one embodiment of the present disclosure, the aforementioned measurement refers to the upper side of the cooling channel structure in the case of beads directed inwards into the battery tray.

According to the present disclosure, a maximum area of the floor of the battery tray is able to be tempered or cooled by means of the cooling channel structure formed from a single piece of material. Due to the direct coupling of the underbody of a battery with a cooling channel structure in the floor of the battery tray, the heat transfer is optimized, whereby the cooling capacity is efficiently increased, while at the same time the use of materials and production costs for manufacturing the battery tray according to the present disclosure with a cooling channel structure is reduced.

In order to ensure continued robustness and a constructive design, at least one connection opening for the cooling channels is offset to the side of the batteries in the battery tray. In at least one embodiment of the present disclosure, the connection opening inside the battery tray is accessible from the inside. This in turn offers the advantage that no cooling medium or other substances is able to escape into the environment in the event of leaks. At the same time, the risk of mechanical defects or mechanical stress in the underfloor area at the transition from a cooling channel to the cooling channel connection is reduced because the corresponding connection is arranged in the interior of the battery tray.

In at least one embodiment of the present disclosure, the cooling channels are distributed in a serpentine pattern across the floor of the battery tray,, for example, when viewed from above. In at least one embodiment of the present disclosure, the cooling channels are an S-shape. Said serpentine or S-shaped line is then distributed across the entire floor in the aforementioned proportions, thus covering a large part of the floor of the battery tray.

In at least one embodiment of the present disclosure, the beads are embossed into the floor of the battery tray in such a way that two cooling channels are arranged in parallel. Two cooling channels thus run parallel to each other in a serpentine pattern across the entire floor. This further increases the effective cooling capacity. However, as defined in the present disclosure, the cooling channel structure is also able to be configured in such a way that a total of one cooling channel is distributed over the entire floor in a serpentine manner.

To further increase the effective cooling capacity, an additional bead is able to be arranged advantageously in the radius or turn of the cooling channel, i.e., a change of direction in the serpentine course of the channel itself. The effective diameter of the cooling channel would widen at the turn, for example, if this turn has a narrow corner radius. The additional bead ensures that the cross-sectional area through which the current flows is kept at a similar level. At the same time, the additional bead itself is able to be curved in its course in the longitudinal direction of the cooling channel. The curvature then occurs in the direction of the turn of the cooling channel. This results in flow control or flow guidance.

In order to further improve the crash performance of the battery carrier according to the present disclosure, the side walls are able to be angled at an angle to a vertical. In at least one embodiment of the present disclosure, this angle is greater than 1 degree. In at least one embodiment of the present disclosure, the battery tray is rectangular in plan view and has transverse side walls at the front and rear, relative to the longitudinal direction of the motor vehicle. Longitudinal side walls are formed on the respective outer sides. The longitudinal side walls are longer than the transverse side walls. In at least one embodiment of the present disclosure, the transverse side walls run at an angle of 3 to 6 degrees to a vertical line. In at least one embodiment of the present disclosure, the longitudinal side walls run at an angle of 8 to 20, or 13 to 20 degrees to a vertical line.

In at least one embodiment of the present disclosure, at least in some sections, a reinforcing plate is coupled over the longitudinal course of such a side wall to the side wall or to the flange and/or floor in the area of the side wall. In cross-section, this results in a closed hollow profile. This is able to be formed as a crash-hollow profile. When subjected to lateral loading of the cross-section, the hollow profile acts according to the principle of a crash box and is able to compress, so that crash energy is reduced by mechanical deformation. In a respective longitudinal direction, the hollow profile then results in a corresponding intersection and an additional load path. For example, in the event of a head-on crash of an electric vehicle, this ensures that the hollow profile of the longitudinal side walls of the battery trays deforms as little as possible in the longitudinal direction of the vehicle and that the batteries inside are protected.

In at least one embodiment of the present disclosure, corner areas of the battery tray which connect the side walls are able to be flared outwards in relation to the side walls. On the one hand, this has advantages in terms of the expected stretching during the forming process. Furthermore, this is advantageous because the reinforcing profiles only have to be formed in sections over the part of the side wall up to the corner area. A frame completely encircling the battery tray is thus able to be dispensed with. This reduces production costs while simultaneously increasing crash performance.

In at least one embodiment of the present disclosure, the battery tray has a tensile strength greater than 1200 MPa, greater than 1350 MPa. However, the tensile strength Rm should not exceed 3000 MPa, or not exceed 2500 MPa in one or more embodiments. In at least one embodiment of the present disclosure, only parts of the battery tray are able to be press-hardened, and to adjust a tensile strength in the aforementioned range. This ensures that a high level of rigidity is provided due to the hot forming and press hardening process, while also achieving a high level of thermal stability, so that even with different thermal loads in the contacting areas of batteries in the battery tray, the battery tray itself is almost completely absorbed over its full surface, so that optimal heat conduction is always ensured. In at least one embodiment of the present disclosure, the tensile strength is at least in the soil and/or in the transition to the side walls in the aforementioned size. In at least one embodiment of the present disclosure, the entire battery tray is hot-formed and press-hardened.

In at least one embodiment of the present disclosure, by means of the additional corrugations in a turn of the cooling channel, the effectively available flow cross-section area is able to remain approximately constant. In at least one embodiment of the present disclosure, additional beads are arranged in the turns. This means that a sharp turn is able to be made at a turn of 90° or 180°. In relation to the total cooling surface provided, the sharp turns maximize the available cooling surface by allowing. For this purpose, an outer radius or curve radius of a maximum of 35 mm and an inner curve radius of a maximum of 50 mm are configured.

In at least one embodiment of the present disclosure, the additional beads are able to be configured to contact the cover plate. However, the additional bead is also able to be configured with a distance of 2 to 5 mm, for example, to the cover plate, depending on the cross-sectional area of the flow to be set. Surprisingly, this has proven to be advantageous for the associated flow in the context of the present disclosure.

In at least one embodiment of the present disclosure, the additional beads are also able to be formed in the cover plate itself and do not necessarily have to be formed directly in the tray floor.

In at least one embodiment of the present disclosure, the cooling channel structure in the floor to be shaped in such a way that has a skid plate function. In at least one embodiment of the present disclosure, if the beads are arranged to face outwards towards the interior of the tray, no cooling fluid is able to enter the floor of the tray or the tray itself when driving onto an object. This effectively eliminates the risk of a short circuit.

Additional beads are able to be formed. Said beads are not part of the cooling channel structure, but have no cooling function and contain no fluids. Said beads are able to provide a skid plate effect or reinforcement in the transverse and/or longitudinal direction.

In at least one embodiment of the present disclosure, the beads for forming the cooling channels are shaped in such a way that they perform a stiffening function in the transverse direction of the motor vehicle and/or in the longitudinal direction of the motor vehicle. For this purpose, the beads are then formed in the transverse direction of the motor vehicle or the longitudinal direction of the motor vehicle over a large part, for example, over the entire width or length of the battery tray. This is able to achieve a corresponding stiffening.

### BRIEF DESCRIPTION OF THE DRAWINGS

Further advantages, features, properties of the present disclosure are the subject matter of the following description. The latter shows exemplary embodiments of the present disclosure and serves to facilitate its understanding. The individual embodiments are able to be combined with each other as desired without departing from the scope of the present disclosure.

In the figures:

FIG. 1 shows a perspective view of a battery tray according to at least one embodiment of the present disclosure,

FIG. 2 shows a cross-sectional view along the section line II-II of FIG. 1 according to at least one embodiment of the present disclosure,

FIG. 3 shows a longitudinal sectional view along the section line III-III of FIG. 1 according to at least one embodiment of the present disclosure,

FIG. 4 shows an analogous embodiment to FIG. 3 according to the section line III-III of FIG. 1 according to at least one embodiment of the present disclosure,

FIG. 5 shows a plan view of a battery tray according to at least one embodiment of the present disclosure,

FIG. 6 shows a view of the battery tray 1 from below according to at least one embodiment of the present disclosure,

FIG. 7A-Fig. 7C show various embodiments according to the present disclosure,

FIG. 8 shows a cross-sectional view with connection for a cooling channel according to at least one embodiment of the present disclosure, and

FIG. 9 shows a plan view of a turn according to at least one embodiment of the present disclosure.

### DETAILED DESCRIPTION

In the figures, the same reference numerals are used for same or similar components, even if a repeated description or illustration is omitted for reasons of simplicity.

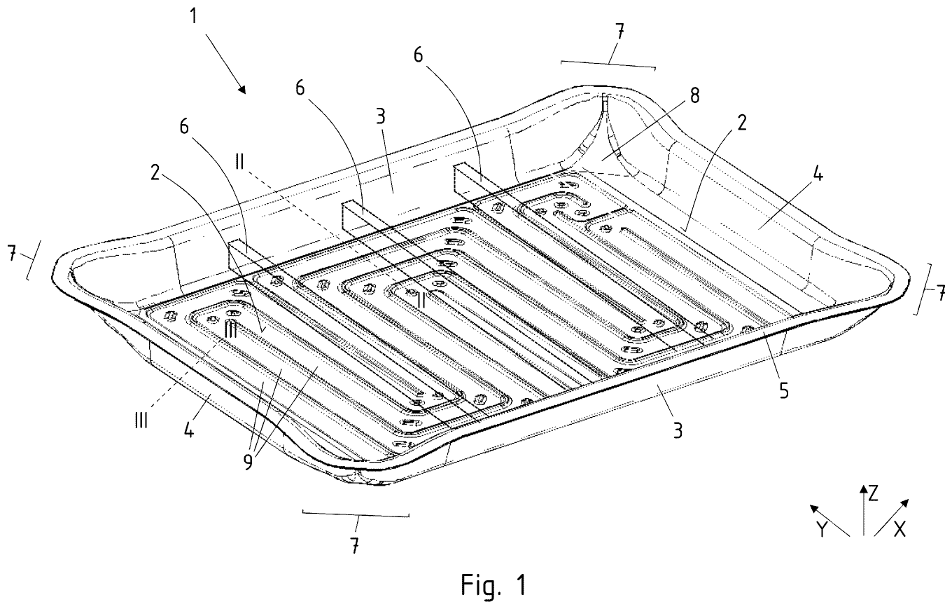

FIG. 1 shows a perspective view according to the present disclosure of a battery tray 1 for a battery carrier not shown in detail in its entirety. For this purpose, the battery tray 1 has a floor 2 with side walls 3 rising from the floor 2 in the form of longitudinal side walls 3 and transverse side walls 4. A flange 5 is provided around the circumference, which is configured to protrude outwards in the horizontal direction of the motor vehicle, i.e. in the XY plane.

Cross members 6, arranged in the battery carrier, are indicated, which extend in the transverse direction Y of the motor vehicle. These are able to provide additional rigidity in the Y transverse direction of the motor vehicle, but are also able to be provided at attachment points for batteries that are not shown in more detail and are arranged in the battery tray 1. Corner areas 7 are flared outwards in relation to the side walls. A curved surface 8 is formed in the corner areas 7. This curved surface 8 is to be seen as a cylinder segment, and therefore two-dimensionally curved and not three-dimensionally curved, thus not a spherical segment-shaped surface. The radius of the curved surface is able to change. The curved surface 8 starts from the floor 2. In at least one embodiment of the present disclosure, a cooling channel structure 9 is now produced integrally in the floor 2 and made from one material by means of forming or molding. For this purpose, the floor 2 is provided with a bead pattern. Said beads are able to be formed inwards in relation to an interior 11 of the battery tray 1, so they protrude inwards over the floor 2. However, the beads are able to alternatively also be formed outwards, relative to an interior 11 of the battery tray 1, thus protruding outwards beyond the floor 2.

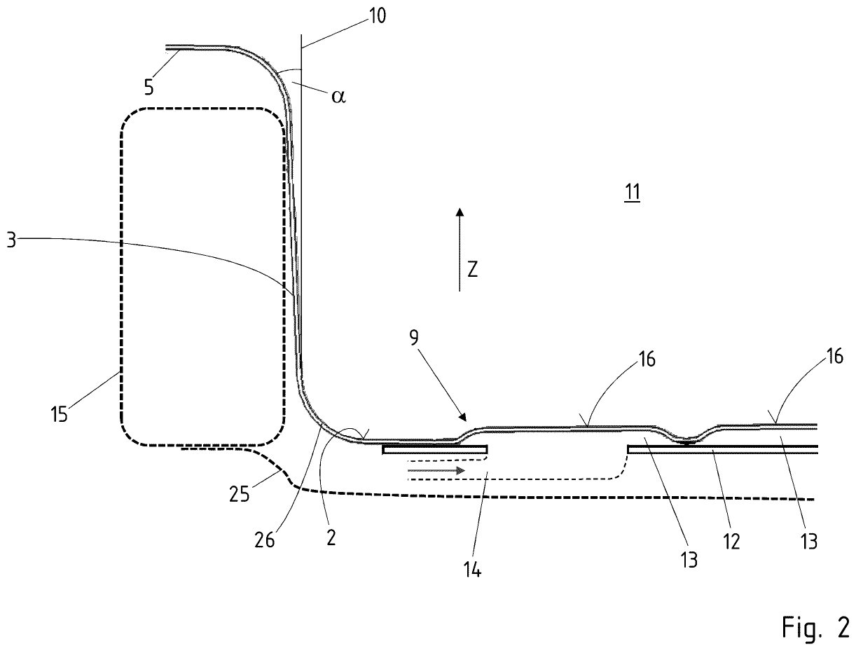

FIG. 2 shows a cross-section along line II-II in FIG. 1 and shows the longitudinal side wall 3 is at an angle a to a vertical line. The vertical is in the Z-direction of the motor vehicle, and therefore in the vertical Z-direction of the motor vehicle. In the embodiment according to FIG. 2, the cooling channel structure 9 is configured such that beads are embossed inwards in relation to an interior 11 of the battery tray 1. A flat or even cover plate 12 is attached. Cooling channels 13 for conducting a cooling medium, which is not described in more detail, are thus formed between the cover plate 12 and the cooling channel structure 11. Furthermore, connection 14 is shown. This comes from outside and penetrates the cover plate 12, arranged underneath the floor 2 of the battery tray 1. In at least one embodiment of the present disclosure, a reinforcement profile 15, here in the form of a frame, is arranged, with an additional skid plate 25.

In at least one embodiment of the present disclosure, however, the cooling channel structure 11 is characterized by the fact that an upper side 16 of the cooling channel structure 11, and thus an upper side 16 of the respective beads, is flat or even. In at least one embodiment of the present disclosure, they run parallel and offset to the floor 2. This flat upper side 16 results in the largest possible surface area in order to arrange batteries (not shown in detail) within the battery tray, so that in turn a correspondingly large surface area is available for heat transfer. The floor 2 then merges into the respective side wall 26 in the transition, in this case the long side wall 3.

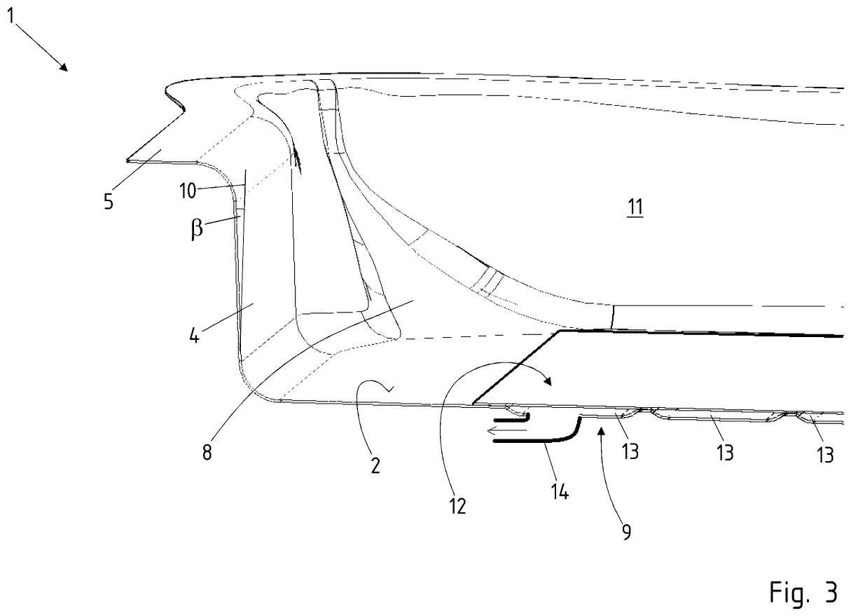

FIG. 3 shows a longitudinal sectional view according to the section line III-III from FIG. 1. In this embodiment, the cooling channel structure 9, with respect to the interior 11 of the battery tray 1, is formed through to the outside. The beads of the cooling channel structure 9 are thus shaped outwards in relation to the floor 2. In at least one embodiment of the present disclosure, a flat cover plate 12 is then inserted into an interior 11 of the battery tray 1. This offers the advantage of maximizing the contact area for a respective underbody of a battery, thus enabling optimal heat conduction between the underbody of a battery and the cover plate 12. The cover plate 12 is joined to the floor 2 of the battery tray 1. This is able to be done, for example, by an adhesive process, but also a thermal joining process, for example welding, or laser welding. This embodiment would again provide a connection 14 on an outer side for the passage of a corresponding cooling medium. Also clearly visible in FIG. 3 is the curved surface 8, which rises up from floor 2 in a two-dimensional curve. In at least one embodiment of the present disclosure, the angle β at which the transverse side wall 4 extends inclined to a vertical direction is also shown.

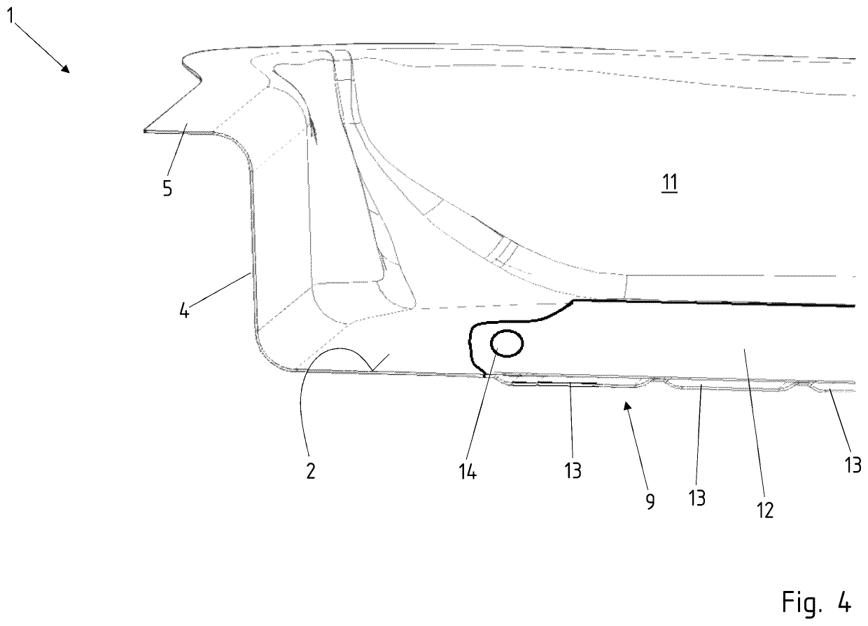

FIG. 4 shows an embodiment analog to FIG. 3 according to the section line III-III from FIG. 1. Here, a cover plate 12 is also arranged from an interior space 11 of the battery carrier and then forms the cooling channels 13 with the shaped beads of the cooling channel structure 9. However, a connection 14 is provided in the interior 11 of the battery carrier, in the battery tray 1. This in turn offers the advantage that the connection 14 cannot be damaged by external mechanical influences. Furthermore, in the event of a leak, no coolant will be discharged into the environment.

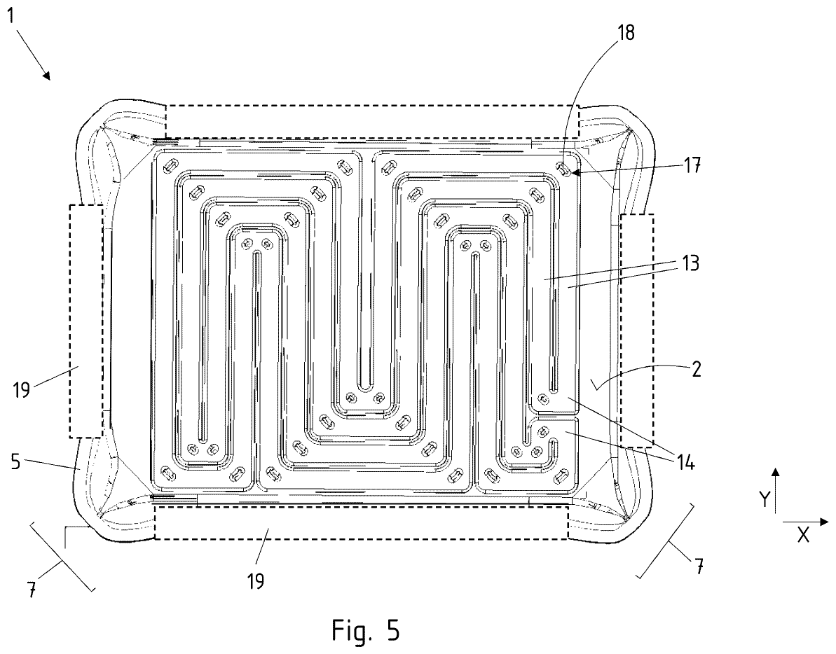

FIG. 5 shows a plan view of a battery tray 1 according to the present disclosure. The two cooling channels 13 extend parallel in a serpentine shape over almost the entire floor. The cooling channels 13 are S-shaped or serpentine-shaped. An additional bead 18 is molded into each respective turn 17, i.e., a change in direction of the cooling channel 13. The turn 17 itself has a small radius. As a result, the cross-sectional area of the cooling channel 13 increases in the area of the turn 17. The additional bead 18 in turn reduces the cross-sectional area in the turn 17. Furthermore, the additional bead 18 is arranged so that to curve in the direction of the turn 17, thus simultaneously controlling the flow. The coolant flow and flow properties are maintained, which optimizes the cooling capacity. For example, the connections are able to be arranged in this area indicated by the reference numeral 14, so that the cooling medium flows through the entire floor once through the two parallel cooling channels 13. For all embodiments of present disclosure, one cooling channel 13 or more than two cooling channels 13 is able to extend over the entire floor.

In at least one embodiment of the present disclosure, additional reinforcing profiles 19 are shown. In the plan view according to FIG. 5, these are drawn in by the dashed-dotted line and are actually located below the flange 5 in the plan view. The reinforcing profiles 19 are coupled in sections with the transverse side wall 4 and/or the longitudinal side wall 3, which are not shown in more detail, and in cross-section they again form a hollow profile with these. The rigidity and crash properties of a battery tray 1 equipped according to the present disclosure are thus improved. In at least one embodiment of the present disclosure, the corner areas 7, in relation to the XY plane, protrude laterally beyond the longitudinal side wall 3 and the transverse side wall 4. This has the advantage of the reinforcing profiles 15 having to be formed only in sections of length and not extending only as far as the start of the respective corner area, not into the corner area or beyond the corner area. A frame that completely encircles the outside as a reinforcing frame is thus able to be avoided according to the present disclosure. This saves material and weight costs while at the same time increasing crash performance.

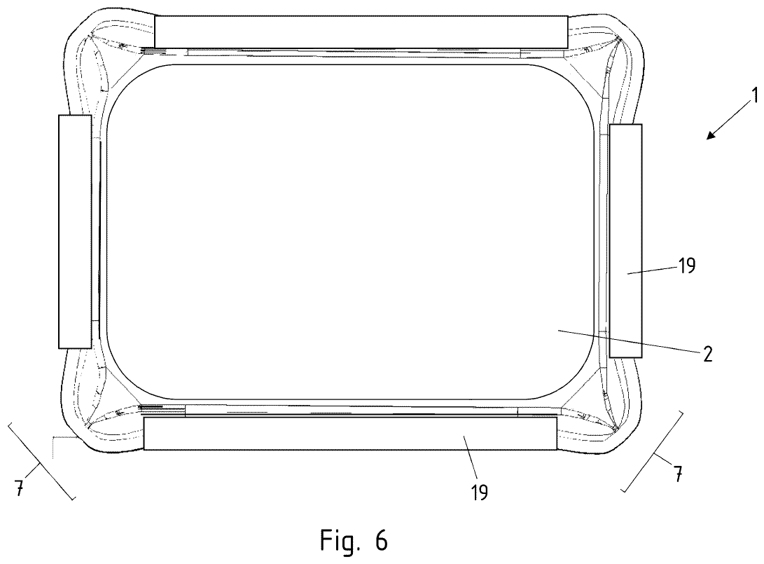

FIG. 6 shows the view of the battery tray 1 from below. The reinforcing profiles 19 are shown here and are each coupled to a longitudinal side wall 3 or transverse side wall 4 behind them. The reinforcing profiles 19 are also able to be coupled at least partially to the flange 5 and/or the floor 2. For reasons of simplification, the cooling channel structure 9 in the floor 2 is not shown in FIG. 6.

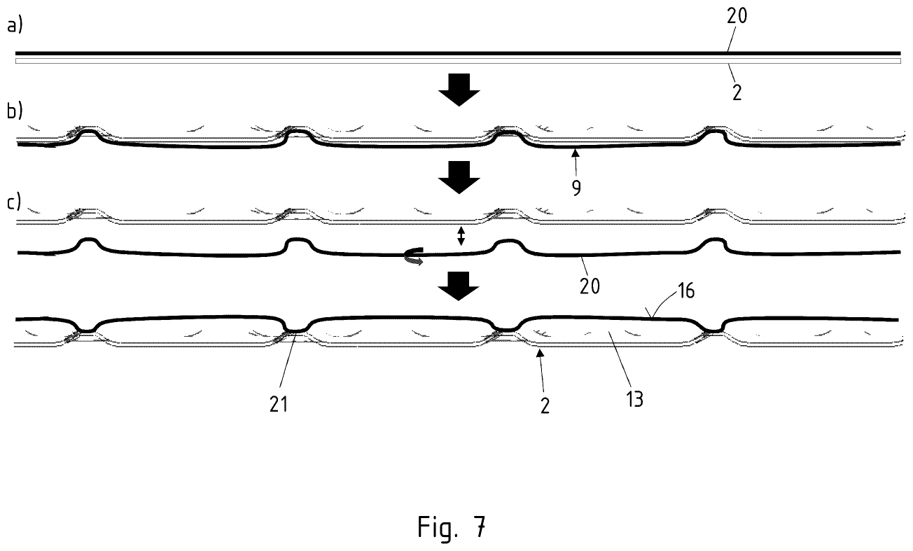

FIG. 7A to FIG. 7C show various embodiments. Here, the floor 2 is shown. Shown is the circuit board, which partially forms the later floor 2 of the battery tray 1. The latter is formed together with an additional plate 20 according to FIG. 7B in a common forming tool, and is therefore designed as a double bearing. The cooling channel structure 9 is then created. The printed circuit boards are spaced apart from each other according to FIG. 7C after forming and the additional printed circuit board 20 is then placed correspondingly on the actual board, which represents the floor 2. Thus, with regard to a later interior 11, there is a straight upper side 16, so that a corresponding receiving surface is provided for batteries that are not shown in more detail. In at least one embodiment of the present disclosure, the additional printed circuit board 20 would then be the later cover plate 12, which has a flat extension, but which itself also has a cooling channel structure 9. These are then able to be bonded or welded at contact surfaces 21, for example, so that cooling channels 13 are formed in the cross-section, which are sealed in themselves.

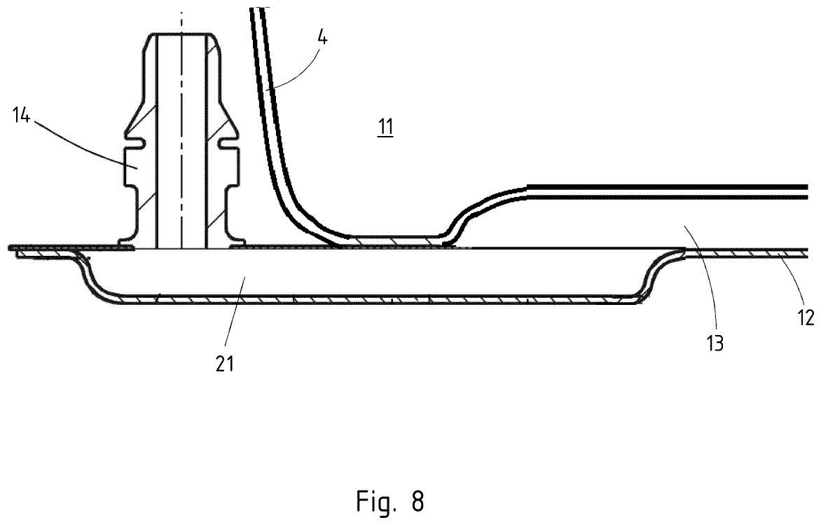

FIG. 8 shows a cross-sectional view. In at least one embodiment of the present disclosure, the cooling channel connection is arranged outside an interior 11. For this purpose, the cover plate 12 is pulled outwards outside the battery tray 1 so that a connection line 22 is formed, to which the actual connection is then coupled. An unspecified cooling fluid is then able to be introduced into the cooling channels. The advantage is that by placing the connection outside of the battery tray 1, no cooling fluid is able to reach the batteries installed in the interior in the event of a leak or crash. This effectively prevents a short circuit and the risk of fire.

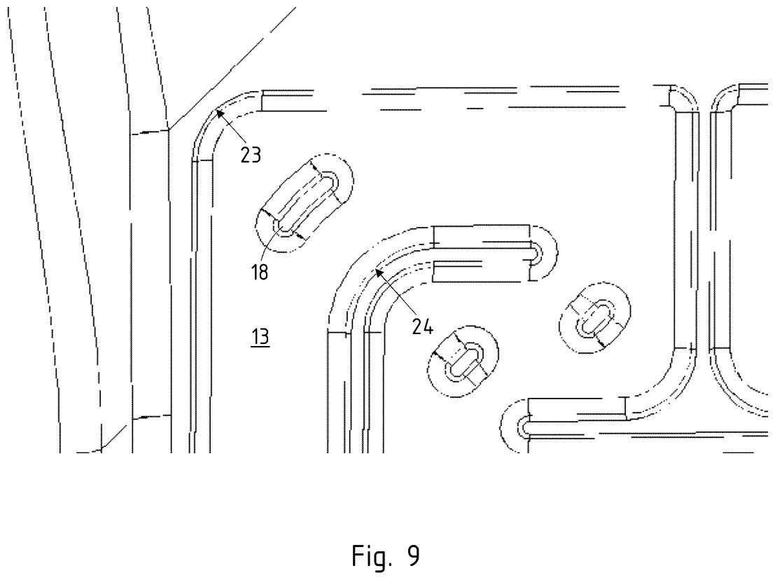

FIG. 9 shows a top view of a turn 17 in which an additional bead 18 is arranged. This results in an outer radius of 23 and an inner radius of 24. The effective flow cross-section area of the cooling channel 13 remains almost constant. At the same time, the radii produce a turn of 90° or even 180° that is as close to a right angle as possible. Due to the resulting sharp turns, the surface available for cooling is effectively maximized and so-called hot spots are avoided.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-16. (canceled)

17. A battery housing for an electric vehicle, comprising:
a battery tray having:
a base,
a plurality of side walls protruding from the base, and
an outwardly protruding flange on a top perimeter of the battery tray,
wherein the base integrally comprises a cooling channel structure; and
a cover plate coupled to the base to configure a plurality of cooling channels between the cooling channel structure and the cover plate.

18. The battery housing of claim 17, wherein the cooling channel structure comprises outwardly formed beads/embossings which protrude outwards or downwards relative to the base.

19. The battery housing of claim 17, wherein the cooling channel structure comprises inwardly formed beads/embossings which protrude inwards into the battery tray opposite the base.

20. The battery housing of claim 17, wherein the cover plate is flat at least in an area opposing the cooling channel structure.

21. The battery housing of claim 17, wherein the cooling channel structure has an area which covers 50 to 95% of a surface area of the base, the area of the cooling channel structure comprising an upper side arranged parallel to the base.

22. The battery housing of claim 17, wherein at least one connection opening of the plurality of cooling channels is outside the battery tray with respect to an interior of the battery tray.

23. The battery housing of claim 17, wherein at least two cooling channels of the plurality of cooling channels extend parallel in a same flow direction.

24. The battery housing of claim 17, wherein an additional bead is in the base in a turn of a cooling channel of the plurality of cooling channels, such that a flow cross-sectional area of the cooling channel remains constant due to the additional bead.

25. The battery housing of claim 24, wherein the additional bead contacts the cover plate.

26. The battery housing of claim 17, wherein the plurality of side walls comprise transverse side walls and longitudinal side walls, wherein the transverse side walls and longitudinal side walls are arranged at an angle greater than 1 degree to a vertical.

27. The battery housing of claim 17, further comprising:
a reinforcing sheet coupled to a side wall of the plurality of side walls at least in length sections, to form a closed hollow profile in cross-section.

28. The battery housing of claim 17, wherein a corner area of the battery tray is flared outwards in relation to the side walls.

29. The battery housing of claim 17, wherein a cooling channel of the plurality of cooling channels has a turn near at least one side wall of the plurality of side walls, such that a flow direction of a cooling fluid is angled by 90° or 180°, wherein the turn has an outer curve radius of a maximum of 35 mm and an inner curve radius of a maximum of 50 mm.

30. The battery housing of claim 17, wherein the cooling channel structure in the base is configured to effect at least one of a skid plate function or stiffening, in at least one of a transverse direction or a longitudinal direction of the electric vehicle.

31. The battery housing of claim 17, wherein the battery tray has a tensile strength Rm greater than 1200 MPa at least in the base and in a transition to the plurality of side walls.

32. The battery housing of claim 17, wherein the battery tray is a hot-formed and press-hardened component from a steel sheet metal blank.

33. The battery housing of claim 17, wherein the cover plate coupled on or below the base of the battery tray.

34. The battery housing of claim 17, wherein the cover plate has a corresponding cooling channel structure opposing the cooling channel structure of the base.

35. The battery housing of claim 24, wherein the additional bead is spaced at a distance of between 2 and 5 mm from the cover plate.

36. The battery housing of claim 17, wherein
the plurality of side walls comprise transverse side walls and longitudinal side walls,
the transverse side walls are arranged at an angle of 3 degrees to 6 degrees of a vertical,
the longitudinal side walls are arranged at an angle of 13 degrees to 20 degrees of the vertical, and
the battery tray has a tensile strength Rm greater than 1350 MPa.
